(19) United States
(12) Patent Application Publication
(10) Pub. No.: US 2016/0122208 A1
(43) Pub. Date: May 5, 2016

(54) Combined Ultraviolet and Ozone Fluid Sterilization System

(71) Applicant: Hayward Industries, Inc., Elizabeth, NJ (US)

(72) Inventors: Ray Denkewicz, East Greenwich, RI (US); Douglas Sawyer, JR., Seekonk, MA (US); James Carter, East Greenwich, RI (US); Jon Stone, Clemmons, NC (US); Seth Renigar, Winston-Salem, NC (US); Rolf Engelhard, Prescott, AZ (US)

(73) Assignee: HAYWARD INDUSTRIES, INC., Elizabeth, NJ (US)

(21) Appl. No.: 14/839,166

(22) Filed: Aug. 28, 2015

Related U.S. Application Data
(60) Provisional application No. 62/043,087, filed on Aug. 28, 2014.

(51) Int. Cl. C02F 1/32; C02F 1/00; C02F 1/78

(52) U.S. Cl. CPC C02F 1/325; C02F 1/78; C02F 1/008; C02F 2303/04; C02F 2201/3228; C02F 2201/782; C02F 2201/328; C02F 2201/326

(57) ABSTRACT

A combined ultraviolet light and ozone fluid sterilization system for sterilizing fluid that includes a removable and replaceable internal reflective sleeve is provided. The sterilization system includes a lower housing, an upper housing, a winged nut, a UV light manifold, a plurality of UV light assemblies, a plurality of UV light securing assembly, and a reflective sleeve. The UV light assemblies include a UV light and an ozone siphon pipe positioned within a quartz casing, which is sealed with an endcap. The ozone siphon pipe of each UV light assembly can be operatively connected with a venturi for introducing ozone into the fluid. The sleeve includes perforated ends which create a more uniform flow within the sleeve, reduce air pockets, normalize the residence time of the fluid molecules, normalize the velocity of the fluid, and increase overall uniformity of treatment.

### CROSS-REFERENCE TO RELATED APPLICATIONS

The present application claims the benefit of priority to U.S. Provisional Patent Application No. 62/043,087, filed on Aug. 28, 2014, the entire disclosure of which is expressly incorporated herein by reference.

### BACKGROUND OF THE INVENTION

1. Field of the Invention

The present invention relates to a fluid sterilization system and, more specifically, to a combined ultraviolet light and ozone fluid sterilization system for sterilizing fluid which includes a removable and replaceable internal reflective sleeve.

2. Related Art

In general, fluid sanitization systems are known. For example, assemblies for sanitizing and/or disinfecting water have been developed. Fluid (e.g., water) sanitization assemblies are useful in a myriad of different environments for various uses/applications, such as commercial and/or industrial applications. In some sanitization systems, ultraviolet lights are used which can emit ultraviolet light in the 254 nanometer and 185 nanometer ranges (UVC). Ultraviolet light in the 254 nanometer range can effectively destroy the nucleic acids in microorganisms, disrupting DNA and removing reproductive capabilities to kill such organisms. Further, ultraviolet light in the 185 nanometer range can convert oxygen present in air into ozone, which can be introduced into the fluid for further sterilization.

Existing systems utilizing ultraviolet light often include internal reflective sleeves for reflecting the emitted ultraviolet light and increasing the effectiveness thereof. However, these sleeves can become tarnished, dented, or otherwise damaged over time. As a result, reflectivity and effectiveness decreases, thereby negatively affecting the fluid sterilization capabilities of the entire system, and sometimes necessitating replacement of the entire system because the reflective sleeves are not easily removed and/or replaced from such systems.

Thus, a need exists for a combined ultraviolet light and ozone fluid sterilization system having an easily accessible and replaceable internal reflective sleeve. This and other needs are addressed by the combined ultraviolet and ozone sterilization system of the present disclosure.

### SUMMARY

The present disclosure is directed to a combined ultraviolet light and ozone fluid sterilization system for sterilizing fluid that includes a removable and replaceable internal reflective sleeve. The sterilization system includes a lower housing, an upper housing, a winged nut, a UV light manifold, a plurality of UV light assemblies, a plurality of UV light securing assembly, and a reflective sleeve. The lower housing defines a central cavity, has an open top and a closed bottom, and includes an inlet and one or more outlets. The inlet can be connected with an inlet fluid supply pipe, and one of the outlets can be connected with an outlet fluid pipe. The inlet pipe can include a venturi. The reflective sleeve is a tubular component that is perforated at both ends and includes a solid central portion. The reflective sleeve is removably positioned within the central cavity of the lower housing, and is removably secured with the lower housing by a plurality of locking tabs that engage the reflective sleeve. The upper housing is connectable to the UV light manifold, which is positionable adjacent the open top of the lower housing and connectable thereto. The UV light manifold and the lower housing can be secured with the winged nut. The UV light assemblies include a UV light and an ozone siphon pipe positioned within a quartz casing, which is sealed with an endcap. The UV light can generate UV light (e.g., UVC light), in both the 254 nanometer range and the 185 nanometer range. The UV light assemblies can each extend through, and be secured to, one of the plurality of UV light securing assemblies. The UV light manifold includes a plurality of UV light mounts, such that each of the UV light assemblies can be inserted into a respective UV light mount and a connected UV light securing assembly can be removably secured to the UV light mount.

The UV light assemblies are replaceable and can be removed from the UV light mount for replacement. The ozone siphon pipe of each UV light assembly can be operatively connected with the venturi, e.g., through a series of tubes, which can generate a suction effect to suction ozone generated by the UV lights through the ozone siphon pipe and introduce the ozone into the fluid stream. The positions and configuration of the reflective sleeve forces turbulent fluid to flow across the first perforated end and into the middle of the reflective sleeve where it is exposed to ultraviolet light, and then across the second perforated end where it exits the lower housing. The perforated ends of the reflective sleeve create a more uniform flow within the reflective sleeve, reduce air pockets, normalize the residence time of the fluid molecules, normalize the velocity of the fluid, and overall increase uniformity of treatment.

The sterilization system can be connected with a control panel that includes a controller, a plurality of ballasts, a plurality of fans, and a display. The controller can be connected with a main board for further control. The controller can include a plurality of power on delay circuits connected with the ballasts for delaying the start time of each ballast to prevent an overload situation.

### BRIEF DESCRIPTION OF THE DRAWINGS

The foregoing features of the invention will be apparent from the following Detailed Description, taken in connection with the accompanying drawings, in which:

FIG. 1 is a perspective view of a fluid sterilization system in accordance with the present disclosure;

FIG. 2 is a front view of the fluid sterilization system of FIG. 1;

FIG. 3 is a rear view of the fluid sterilization system of FIG. 1;

FIG. 4 is a right side view of the fluid sterilization system of FIG. 1;

FIG. 5 is a left side view of the fluid sterilization system of FIG. 1;

FIG. 6 is a top view of the fluid sterilization system of FIG. 1;

FIG. 7 is a bottom view of the fluid sterilization system of FIG. 1;

FIG. 8 is an exploded view of the fluid sterilization system of FIG. 1;

FIG. 8A is a perspective view of another embodiment of the reflective sleeve of the present disclosure;

FIGS. 9-10 are sectional views of the fluid sterilization system taken along line 9-9 of FIG. 6;

FIG. 11 is a perspective view of an ultraviolet light assembly and an associated light end cap assembly of the fluid sterilization system of FIG. 1;

FIG. 12 is an exploded perspective view of the ultraviolet light assembly of FIG. 11;

FIG. 13 is a top view of the ultraviolet light assembly and UV light end cap assembly of FIG. 11;

FIG. 14 is a perspective view of a control panel for controlling the fluid sterilization system;

FIG. 15 is a perspective view of the control panel of FIG. 14, showing the front cover removed and internal components of the control panel; and

FIG. 16 is an electrical schematic diagram of a controller included in the control panel of FIG. 14.

### DETAILED DESCRIPTION

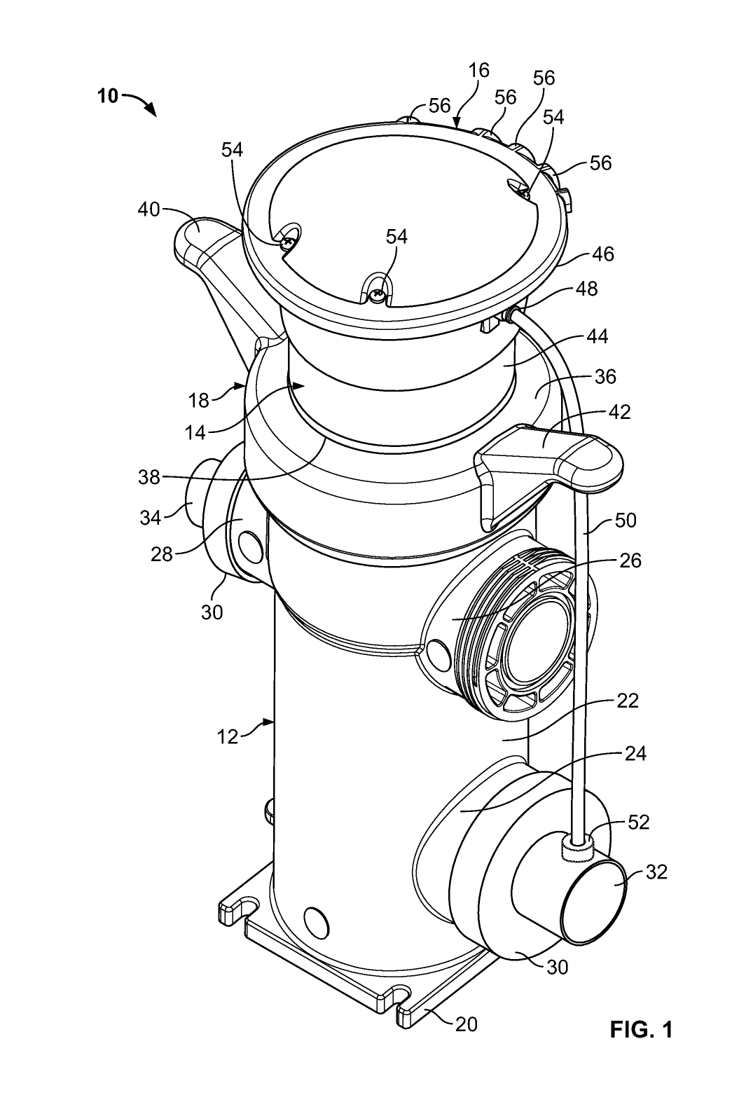

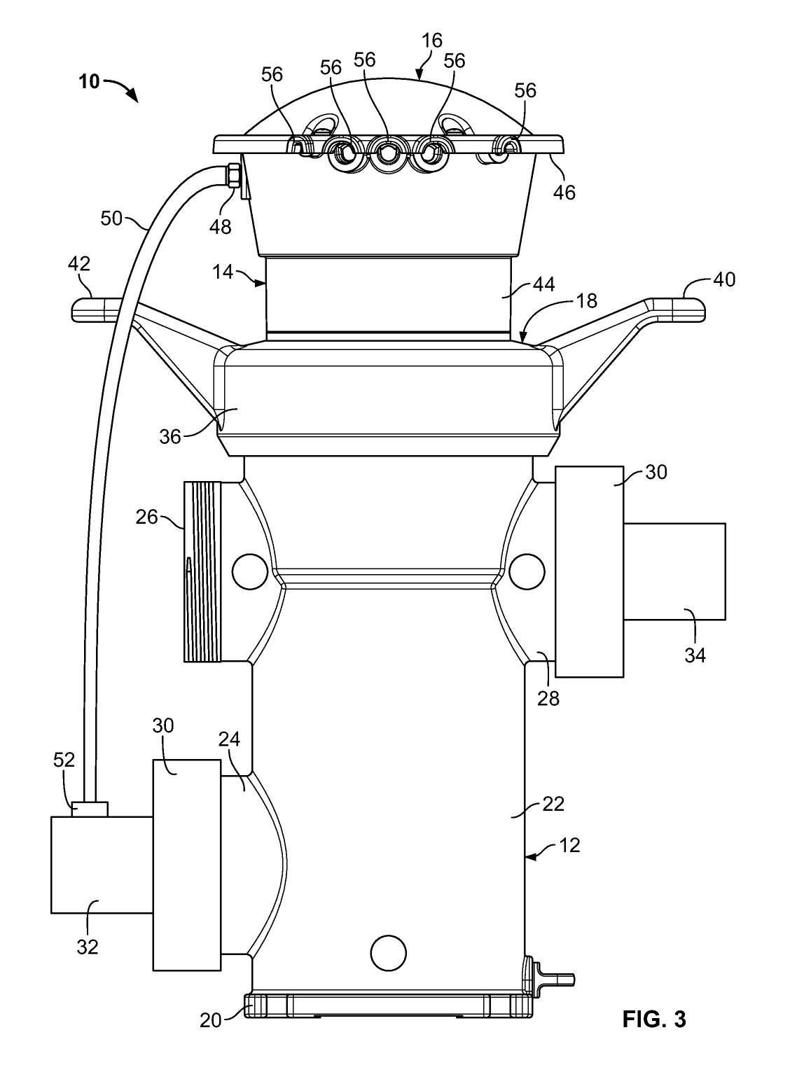

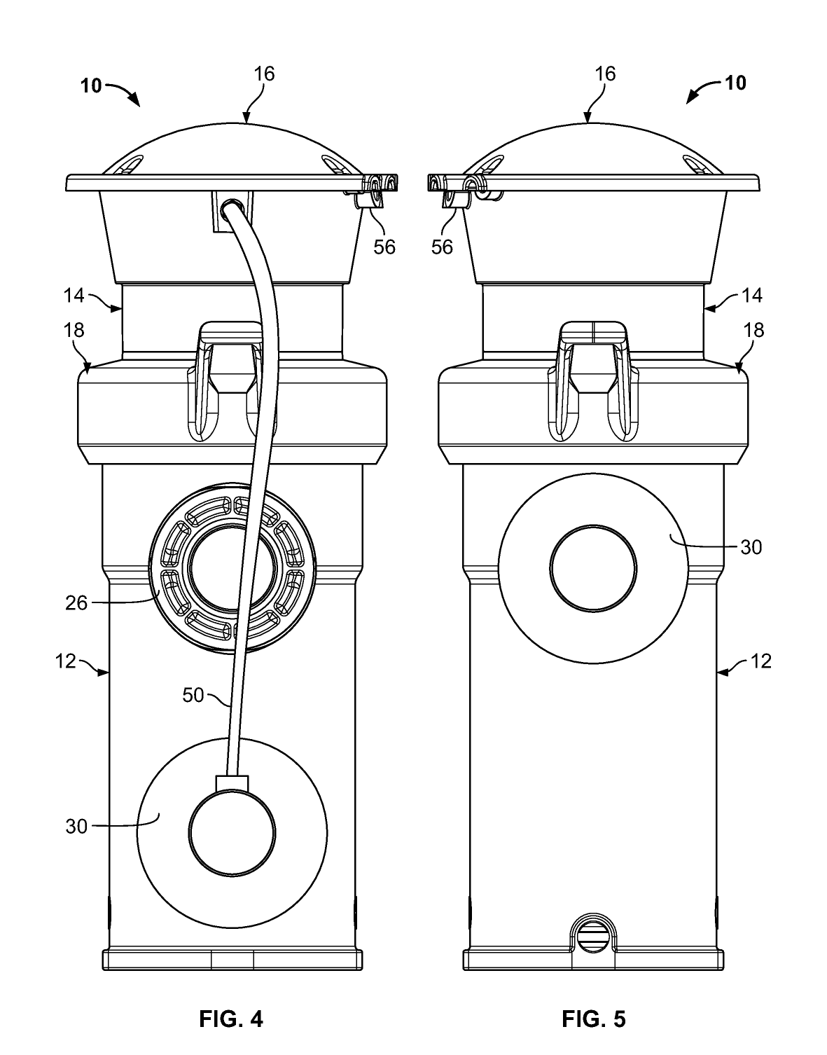

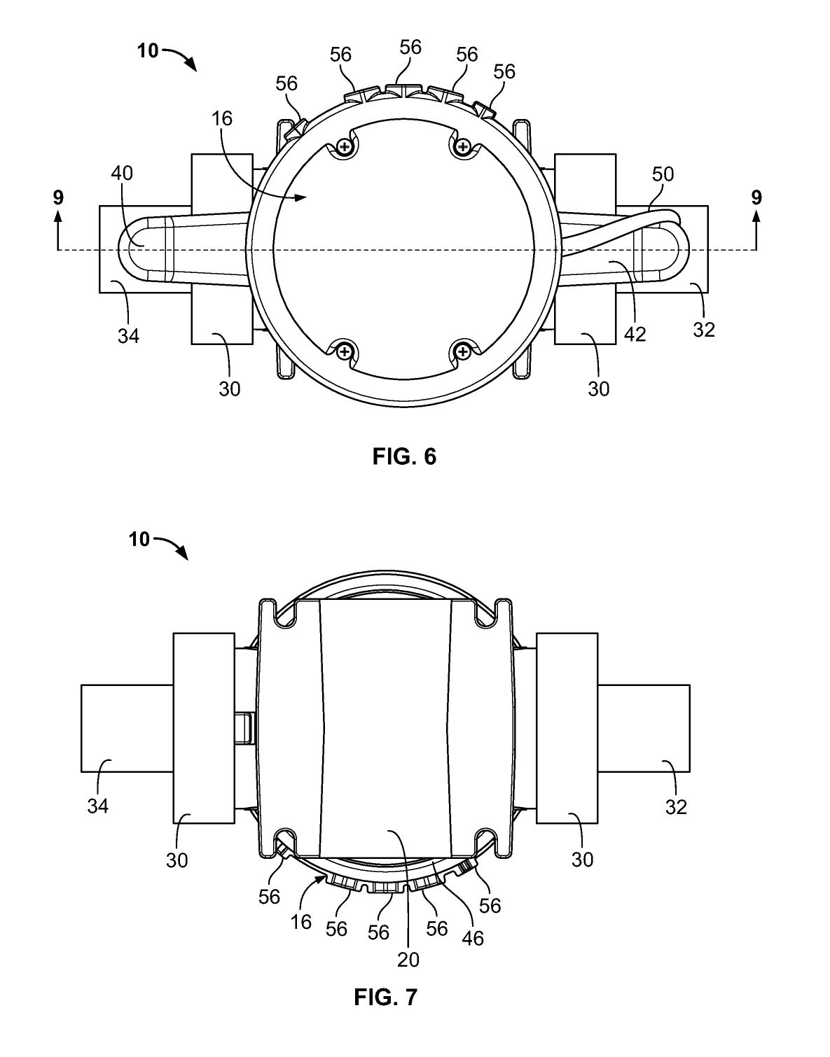

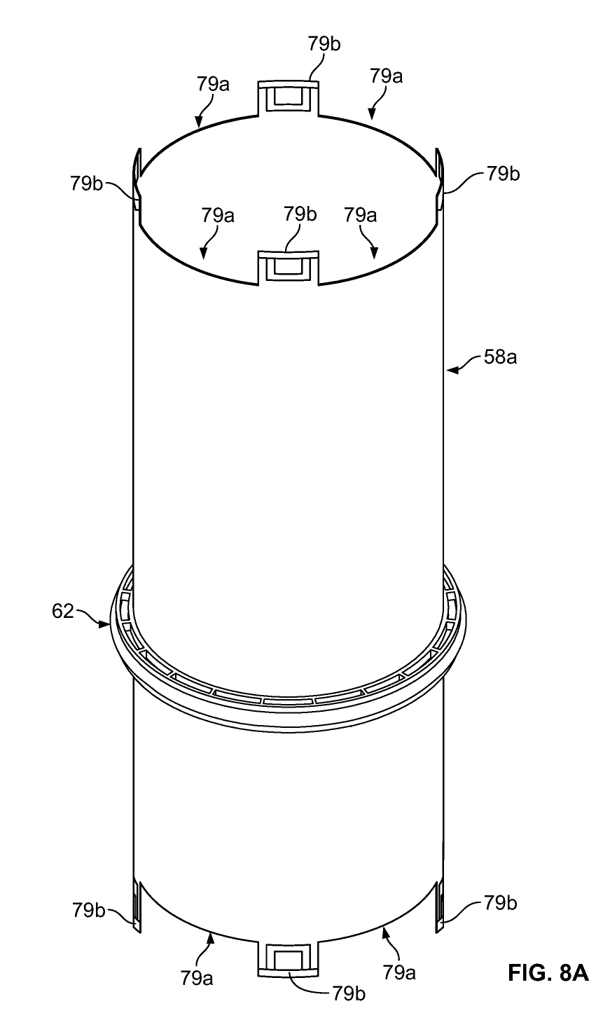

The present disclosure relates to a combined ultraviolet light and ozone fluid sterilization system, as described in detail below in connection with FIGS. 1-16.

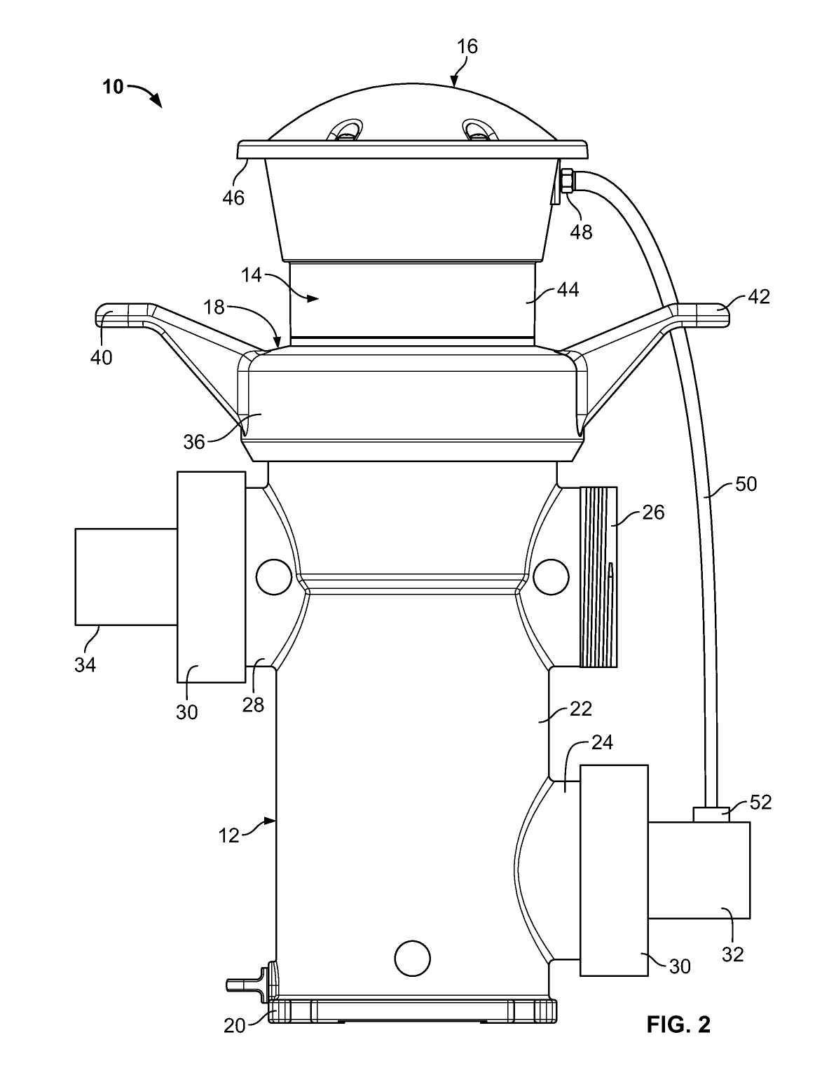

With specific reference to FIGS. 1-10, an ultraviolet (“UV”) and ozone fluid sterilization system 10 is illustrated. In particular, FIG. 1 is a perspective view of the sterilization system 10, and FIGS. 2-7 are respectively, front, rear, right side, left side, top, and bottom views of the sterilization system 10. The sterilization system 10 can be installed in the return fluid line (e.g., fluid conduits) of a pool or spa filtration system, in industrial applications, or in the return fluid lines of aquariums. The sterilization system 10 includes a lower housing 12, an upper housing 14, a cap 16, and a winged nut 18. The lower housing 12 includes a base 20, a tubular body 22, an inlet port 24, a first outlet port 26, and a second outlet port 28. The inlet port 24 can be located adjacent to the base 20 at a first end of the tubular body 22, and the first and second outlet ports 26, 28 can be located at a second end of the tubular body 22 opposite the first end. The first and second outlet ports 26, 28 can be generally coaxial aligned and located opposite one another, and the inlet port 24 can be longitudinally aligned with one of the first or second outlet ports 26, 28. Generally, only one of the outlet ports 26, 28 would be used while the other outlet port 26, 28 can be sealed with a cap (not shown), but of course, both ports 26, 28 could be used if desired. Positioning of the two outlet ports 26, 28 opposite one another allows a user to install the sterilization system 10 at various locations based on where the return line to the pool or spa is located. The inlet port 24 and the outlet ports 26, 28 can be externally threaded to allow an internally threaded fitting 30 to be threadably attached thereto. The fitting 30 can be configured to secure an inlet pipe 32 to the inlet port 24, and an outlet pipe 34 to one of the outlet ports 26, 28.

The upper housing 14 is secured to the UV light manifold 64 by screws 110. The UV light manifold 64 is secured to the lower housing 12 by the winged nut 18. The winged nut 18 includes a body 36, a central opening 38, and first and second wings 40, 42 that facilitate user attachment and detachment of the winged nut 18 to the lower housing 12. The upper housing 14 includes a body 44, an upper rim 46, and an outlet port 48. A venturi tube 50 is connected to the outlet port 48 of the upper housing 14 and runs to a venturi 52 that is positioned on the inlet pipe 32. The outlet port 48, venturi tube 50, and venturi 52 are discussed in greater detail below. The cap 16 is positioned adjacent the upper rim 46 of the upper housing 14, and is connected to the upper housing 14 by a plurality of screws 54. When connected, the cap 16 and the upper housing 14 form a plurality of inlets 56. The inlets 56 provide access points for various electrical cables/wiring.

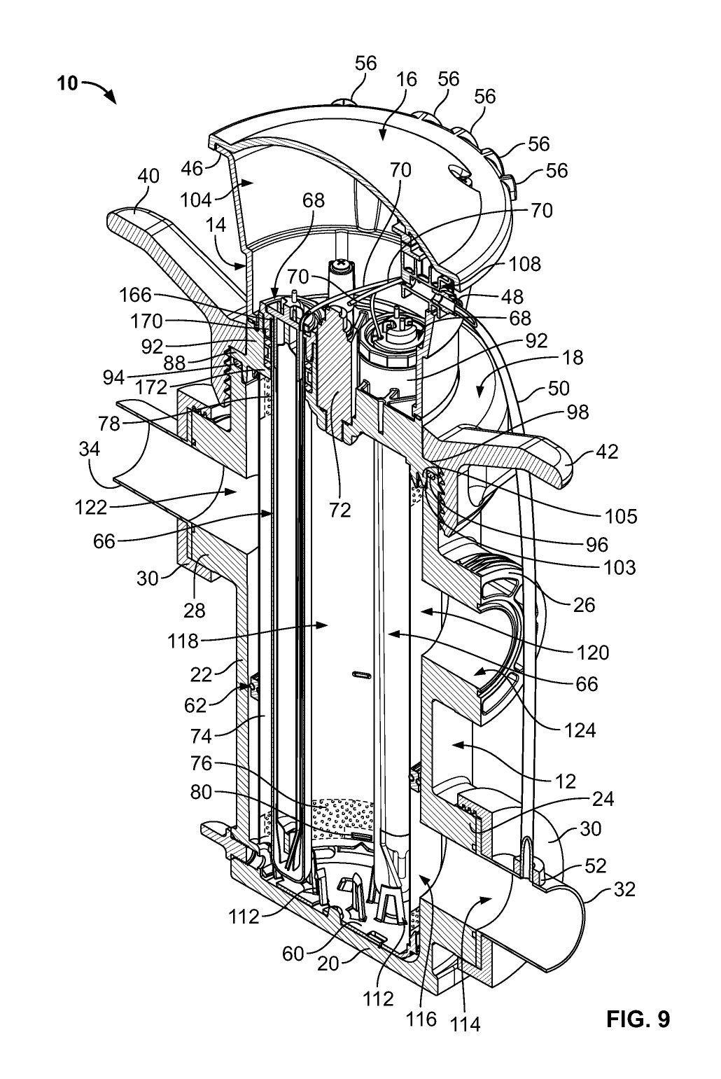

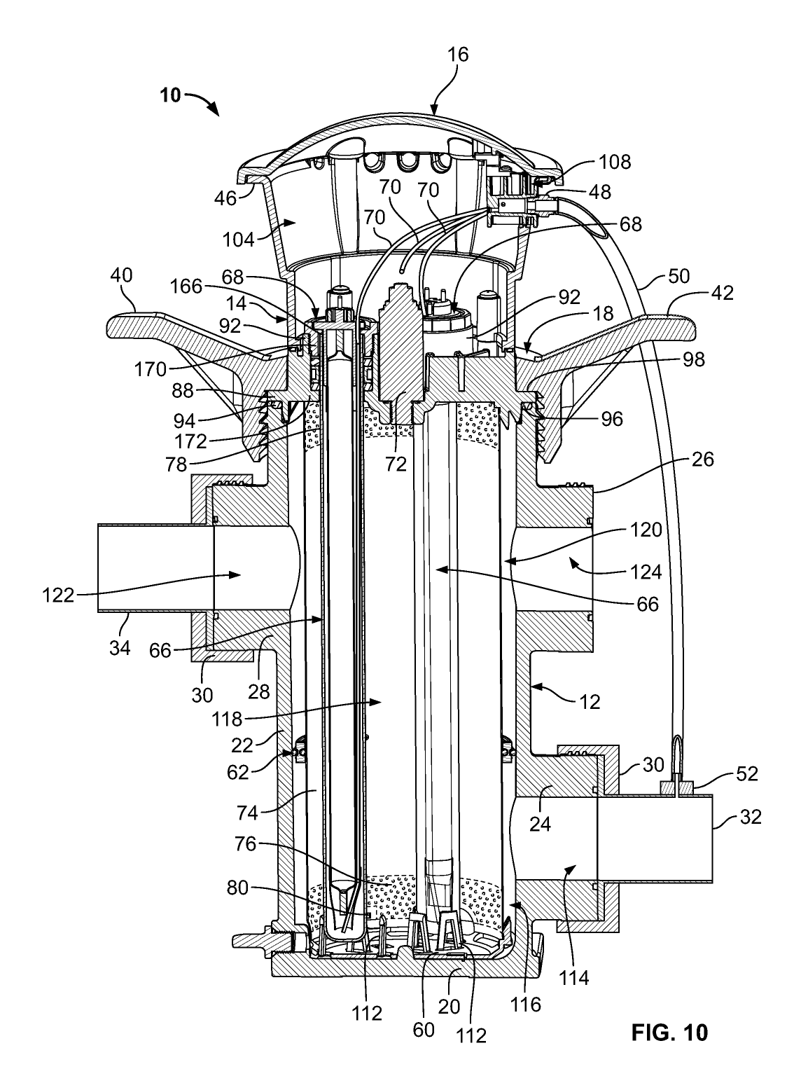

FIG. 8 is an exploded perspective view of the sterilization system 10 of FIG. 1 showing the components in greater detail. The sterilization system 10 further includes a reflective sleeve 58, a bottom plate 60, an O-ring assembly 62, a UV light manifold 64, a plurality of UV light assemblies 66, a plurality of UV light securing assemblies 68, and a plurality of ozone siphon tubes 70. The UV light manifold 64 includes a sensor 72 connected thereto. The sensor 72 can include a UV light intensity sensor and/or an interlock alarm. The UV light intensity sensor can measure the intensity of the UV light being emitted and generate an alarm if the UV light is below a certain percentage of a normal operating intensity, e.g., an audible alarm can be sounded if the UV light emitted is less than 70% of the normal operating intensity. The normal operating intensity can be calibrated when a new UV light bulb is inserted and based thereon. The interlock alarm can turn the UV light assemblies 66 off when the system 10 is opened so that a user's eyes are not directly exposed to the illuminated UV light assemblies 66.

The reflective sleeve 58 is tubular in shape and has a solid central annular portion 74, a perforated lower annular portion 76, and a perforated upper annular portion 78. The reflective sleeve 58 connects to the bottom plate 60 by a plurality of snap-style locking tabs 80. The locking tabs 80 removably secure the reflective sleeve 58 in place, and allow the reflective sleeve 58 to be removed. Additionally, the reflective sleeve 58 is secured to the UV light manifold 64, which can include a plurality of locking tabs such as the locking tabs 80. Optionally, a separate and independent top plate could be provided and connected to the reflective sleeve 58. As such, the reflective sleeve 58 is removable and replaceable. This is beneficial as the reflective sleeve 58 can become tarnished over time, damaged, or dented for various reasons. In such instances, the reflective sleeve 58 could have a reduced level of reflectivity. When the reflectivity of the sleeve 58 is reduced, it can be desirable to remove and replace the damaged reflective sleeve 58 with a new one. In such circumstances, a user would simply disassemble the sterilization system 10, remove the damaged reflective sleeve 58, and replace it with a new reflective sleeve. Alternatively, a user can remove the reflective sleeve 58 for cleaning and/or maintenance purposes. The reflective sleeve 58 is generally formed of a material that reflects ultraviolet light and does not absorb ultraviolet light. For example, the reflective sleeve 58 can be made of, or coated with, a plurality of different materials, including, but not limited to, stainless steel, composites, reflectively coated thermoplastics, reflective PTFE or PFA, etc. It is noted that perforations need not be provided on the sleeve 58, and that a single opening could be provided on each of the top and bottom portions of the sleeve 58, if desired, to allow water inflow and outflow for the sleeve 58 while still achieving the desired flow characteristics through the sleeve 58.

An alternative embodiment of the reflective sleeve 58 is shown in FIG. 8A, which is a perspective view of an alternative reflective sleeve 58a. The alternative reflective sleeve 58a includes a plurality of cut-outs 79a that replace the perforated lower and upper annular portions 76, 78 of the reflective sleeve 58 and form stand-offs 79b. The lower stand-offs 79b engage the bottom plate 60. Fluid flows across the cut-outs 79a of the sleeve 58a (as it would flow through the perforated annular portions 76, 78 of the reflective sleeve 58). The sleeve 58a of FIG. 8A is similar in structure and construction to the reflective sleeve 58 of FIG. 8 and includes all the same characteristics thereof except where identified otherwise.

The perforations of the sleeve 58 shown in FIG. 8 can be used to increase open flow area without losing 100% of the reflective surface for a particular area. Particularly, if a perforation size and pattern is chosen with an open area of 45%, then 55% of the stainless steel around the perforations remains intact and contributes to the reflectivity of the sleeve 58 in the perforated lower and upper annular portions 76, 78. This is in contrast to a configuration where an entire region, e.g., 100% of an area, is removed to accommodate for an opening, wherein the reflectivity contribution would be lost in this area and would not be evenly distributed around an inner surface of the sleeve. Additionally, the perforations in the sleeve 58 increase the exposure time of some of the water entering the sleeve 58 because the perforations allow some UV light to escape the confines of the sleeve 58 and start exposing the water to UV before it enters the sleeve 58.

As illustrated in FIG. 8, the lower housing 12 defines a central cavity 82 and includes an upper opening 84. The lower housing 12 receives the reflective sleeve 58 through the upper opening 84, and houses the reflective sleeve 58 in the central cavity 82 thereof. When the reflective sleeve 58 is within the central cavity 82 of the lower housing 12, the O-ring assembly 62 engages an internal wall of the lower housing tubular body 22, and the outer wall of the solid center portion 74 of the sleeve 58 and creates a generally fluid-tight seal between the solid center portion 74 of the reflective sleeve 58 and the lower housing tubular body 22. The fluid-tight seal created by the O-ring assembly 62 mechanically separates the central cavity 82 into an untreated portion and a treated portion, as discussed in greater detail below. Additionally, this seal prevents the bypass of untreated water into the treated water portion, thus ensuring that all of the fluid flowing through the vessel is treated.

The UV light manifold 64 includes an annular wall 86, an annular flange 88 extending radially from the annular wall 86, a plurality of mounting holes 90, and a plurality of UV light mounts 92. The UV light manifold 64 includes a number of mounting holes 90 and UV light mounts 92 corresponding to the number of UV light assemblies 66 to be implemented in the system 10. In some embodiments, the UV light manifold 64 is interchangeable such that a user can have different UV light manifolds 64 for accommodating different specific applications. For example, the UV light manifold 64 can have a different number of UV light assemblies 66, e.g., three, four, five, etc. In such instances, a user might desire more or less UV light assemblies 66 based upon the need to increase or decrease the intensity and/or dosage of the UV light. The UV light manifold 64 is positionable over the lower housing 12 with the annular flange 88 being adjacent the upper opening 84 of the lower housing 12. The upper opening 84 can include a groove 94 that houses an O-ring 96. When the UV light manifold 64 is positioned adjacent the upper opening 84, the O-ring 96 is within the groove 94 and between the UV light manifold annular flange 88 and the groove 94. The winged nut 18 includes an annular shoulder 98 that extends radially inward to form the central opening 38, and internal threading 100. The winged nut 18 can be positioned over the UV light manifold 64 and threadedly secured to the lower housing 12 through engagement of the winged nut's internal threading 100 with external threads 102 of the lower housing 12, which are adjacent the groove 94 and upper opening 84. As the winged nut 18 is threadedly engaged with the lower housing 12, the annular shoulder 98 of the winged nut 18 engages the UV light manifold annular flange 88. Further tightening of the winged nut 18 compresses the O-ring 96 between the UV light manifold annular flange 88 and the groove 94, creating a water-tight seal.

Additionally, the groove 94 can include one or more notches 103 while the UV light manifold 64 can include one or more bosses 105 extending from a bottom of the annular flange 88. The bosses 105 are sized and positioned to engage the notches 103 when the UV light manifold 64 is placed over the lower housing 12. The spacing and engagement of the bosses 105 with the notches 103 ensures proper orientation and alignment of the UV light manifold 64, and subsequently the UV light assemblies 66, relative to the inlet port 24 and outlet ports 26, 28 during assembly of the sterilization assembly 10.

The upper housing 14 can also be attached to the UV light manifold 64. Specifically, the upper housing 14 defines an interior space 104, and includes internal mounts 106 and a siphon tube manifold 108 that includes the outlet port 48. A portion of the upper housing body 44 is configured to be positioned over the annular wall 86 of the UV light manifold 64, and connected to the UV light manifold 64 by a plurality of screws 110 that engage the plurality of mounting holes 90 of the UV light manifold 64. The cap 16 is then attached to the upper housing 14 by screws 54.

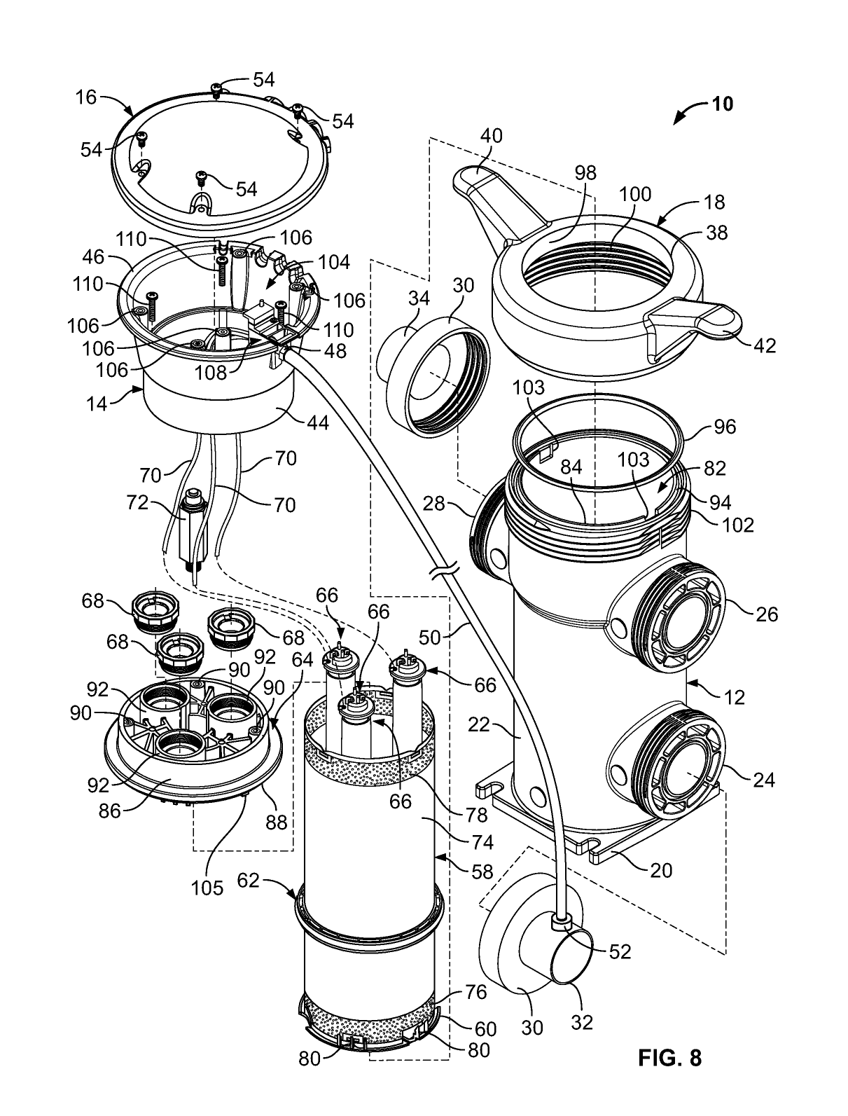

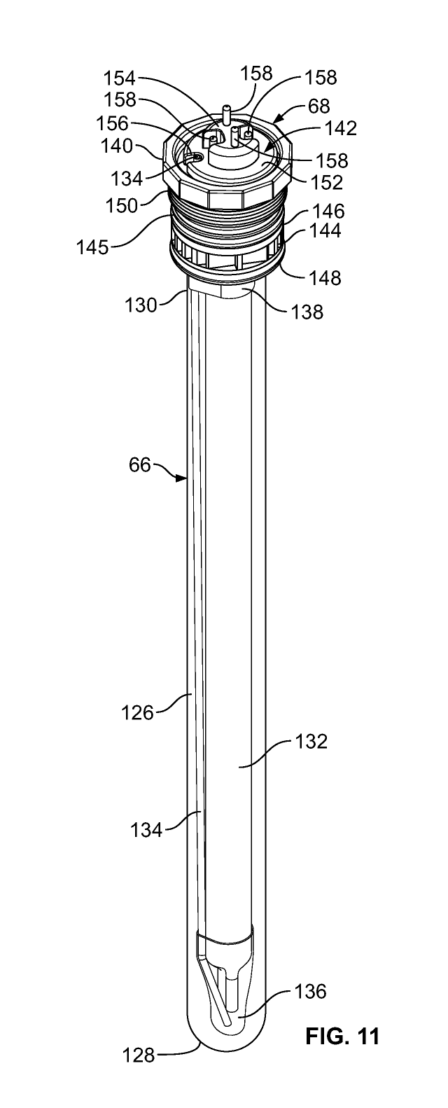

FIG. 9 is a first sectional view of the sterilization system 10, and FIG. 10 is a second sectional view of the sterilization system 1, both taken along the line 9-9 of FIG. 6. As can be seen in FIGS. 9 and 10, when the sterilization system 10 is fully assembled, the UV light assemblies 66 are positioned within the interior of the reflective sleeve 58, which is positioned within the lower housing 12. The UV light assemblies 66 generally extend the length of the reflective sleeve 58 to the bottom plate 60. The bottom plate 60 includes a plurality of positioning tabs 112 that form groups matching the UV light assemblies 66. The positioning tabs 112 are located on the bottom plate 60 so that each group is aligned with a respective UV light assembly 66 and surrounds a bottom portion of the respective UV light assembly 66. Accordingly, the positioning tabs 112 act to position the UV light assemblies 66 and prevent the UV light assemblies 66 from lateral movement.

When the sterilization system 10 is fully assembled, there are a plurality of distinct regions for fluid flow. Specifically, there is an inlet flow region 114, a pre-sterilization region 116, a sterilization region 118, a post-sterilization region 120, a first outlet flow region 122, and a second outlet flow region 124. The pre-sterilization region 116, sterilization region 118, and post-sterilization region 120 are within the tubular body 22 of the lower housing 12. The inlet flow region 114 is formed by the inlet port 24 and provides fluid to the pre-sterilization region 116, which is internal to the lower housing 12. The pre-sterilization region 116 is an annular region formed external to the sleeve 58, and between the sleeve 58, the tubular body 22, and the O-ring assembly 62. The pre-sterilization region 116 is adjacent the inlet flow region 114. The sterilization region 118 is a tubular flow region that is internal to the sleeve 58. The post-sterilization region 120 is similar to the pre-sterilization region 116, and is an annular region formed external to the sleeve 58 between the sleeve 58, the tubular body 22, and the O-ring assembly 62. The post-sterilization region 120 is adjacent the first and second outlet flow regions 122, 124. The pre-sterilization region 116 and the post-sterilization region 120 are external to the sleeve 58 and separated from one another by the O-ring assembly 62. The flow of fluid through the sterilization system 10 is discussed in greater detail below.

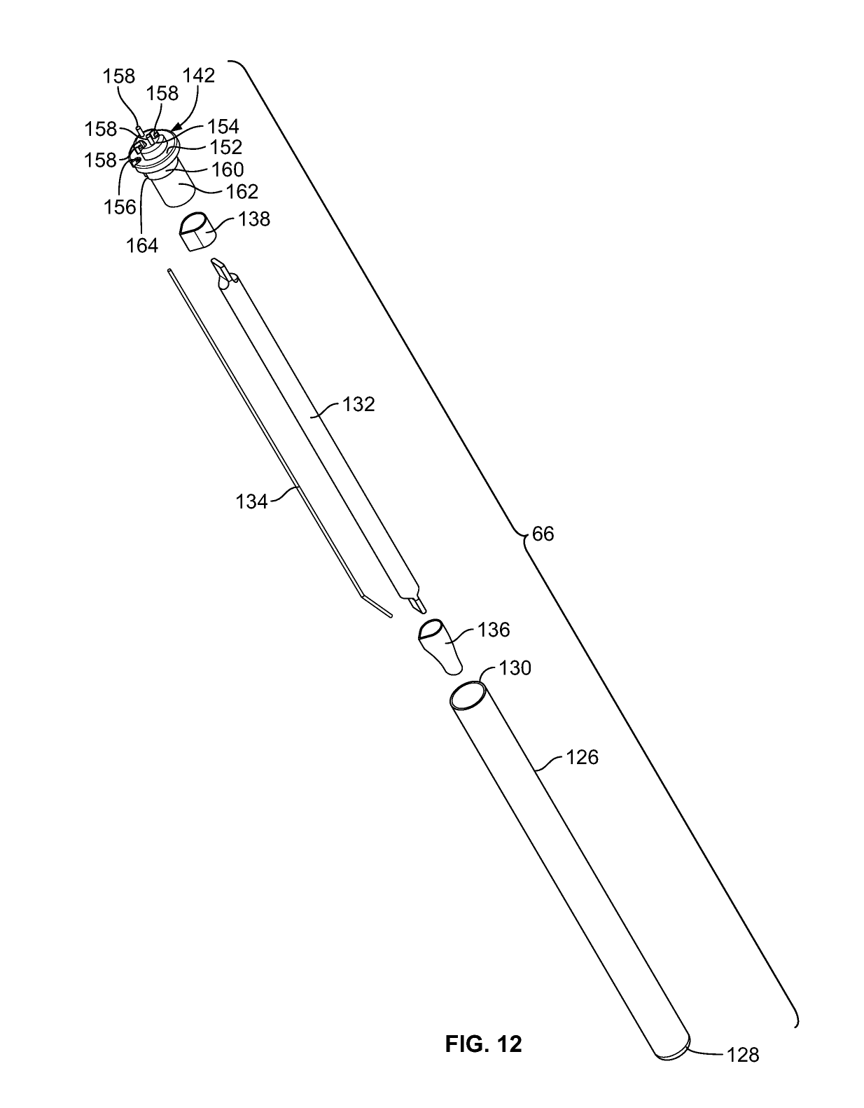

FIGS. 11-13 show the UV light assemblies 66 and UV light securing assembly 68 in greater detail. Each of the UV light assemblies 66 further include a quartz casing 126 having a closed lower end 128 and an open upper end 130, a low pressure ultraviolet amalgam lamp 132, an ozone siphoning pipe 134, a first fastener 136, a second fastener 138, and an end cap 142. The UV light securing assembly 68 includes a securing collar 140, a spacer 144, a washer 145, and first and second O-rings 146, 148. The spacer 144, the washer 145, and the first and second O-rings 146, 148 are placed around the quartz casing 126, with the spacer 144 being placed between the first and second O-rings 146, 148, and the washer 145 being placed between the first O-ring 146 and the securing collar 140. The first and second O-rings 146, 148 engage the quartz casing 126 and the respective UV light mount 92 when the UV light assembly 66 is installed therein to create a water proof seal therewith.

The securing collar 140 includes an externally threaded wall 150 for securing with one of the UV light mounts 92. The end cap 142 includes a base 152 and a shaped boss 154 extending from the base 152. The base 152 includes a removed section or notch 156 that provides a space for the ozone siphoning pipe 134 to extend through and connect with one of the ozone siphon tubes 70. A plurality of electrical contact pins 158 extend through the end cap 142. As shown, two contact pins 158 extend through the end cap base 152 and two contact pins 158 extend through the end cap boss 154, each of which is in electrical communication with the UV amalgam lamp 132. The shaped boss 154 is generally shaped with a matching geometry to a plug (not shown) for connecting the UV light assembly 66 with a power and/or control source.

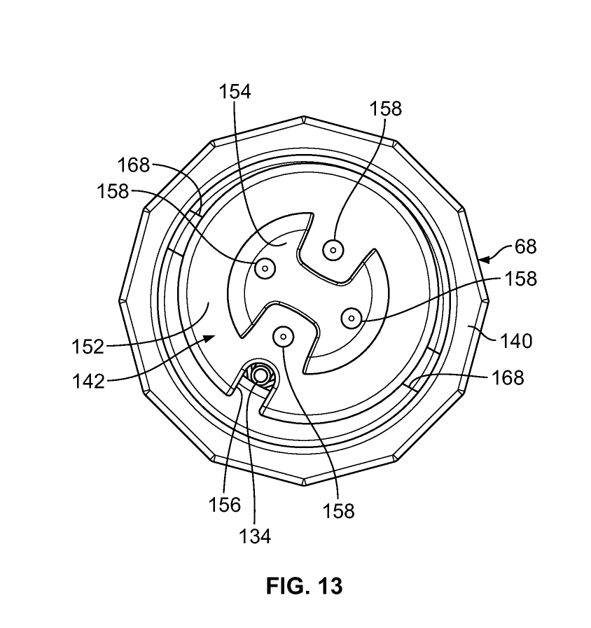

As shown in FIG. 12, which is an exploded view of the light assembly 66, the end cap 142 also includes a centered cylindrical wall 160 extending from the base 152 and an off-center cylindrical wall 162 extending from the centered cylindrical wall 160. The centered cylindrical wall 160 includes a notch 164 that is aligned with the base notch 156. This off-centered arrangement allows the ozone siphoning pipe 134 to extend along the off-centered cylindrical wall 162, and across the centered cylindrical wall notch 164 and the base notch 156.

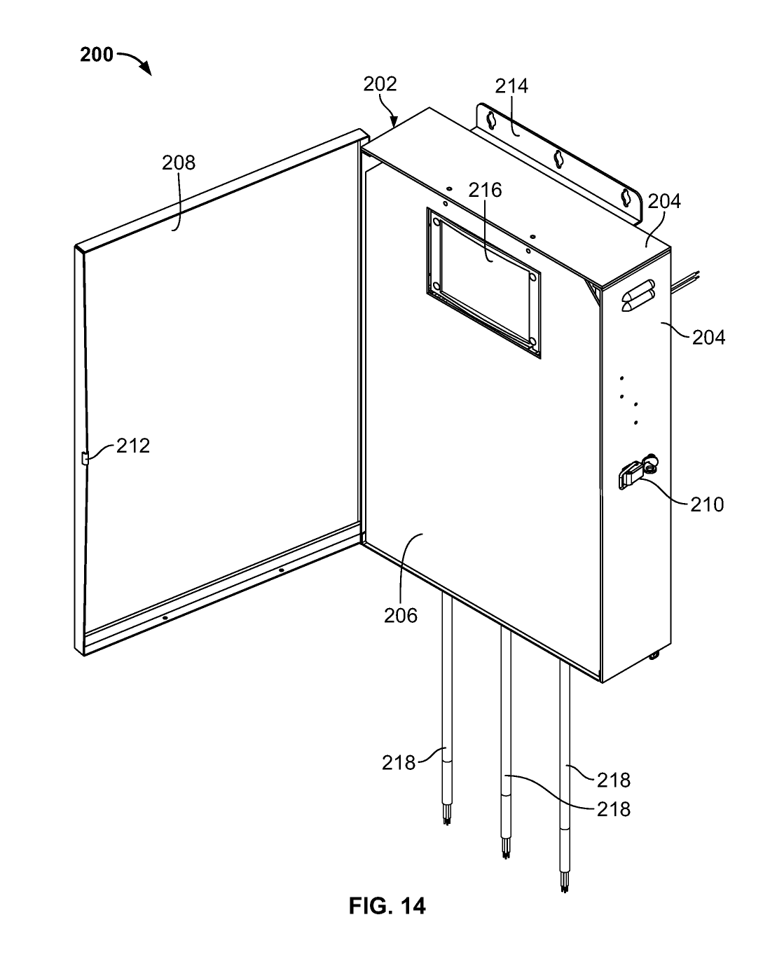

The UV light assemblies 66 are each configured as follows: the securing collar 140 is placed over the centered and off-center cylindrical walls 160, 162 of the end cap 142 such that the securing collar 140 is adjacent the end cap base 152. The UV lamp 132 is secured with the ozone siphoning pipe 134 by the first and second fasteners 136, 138, such that the ozone siphoning pipe 134 generally extends across the entirety of the UV lamp 132. The first and second fasteners 136, 138 retain the ozone siphoning pipe 134 in close proximity to the UV lamp 132. The UV lamp 132 is inserted into the off-center cylindrical wall 162 of the end cap 142 and engages the contact pins 158 extending through the end cap 142. The ozone siphoning pipe 134 is positioned on the outside of the off-center cylindrical wall 162 and extends across the centered cylindrical wall notch 164 and the base notch 156. The quartz casing 126 is positioned over the UV lamps 132, the first and second fasteners 136, 138, the ozone siphoning pipe 134, the end cap centered cylindrical wall 160, and the end cap off-center cylindrical wall 162, and is between the interior face of the externally threaded wall 150 of the securing collar 140 and the end cap's centered cylindrical wall 160. The open end of the quartz casing 126 abuts an internally extending radial shoulder 166 (see FIG. 9). The washer 145, the first O-ring 146, the spacer 144, and the second O-ring 148 are then placed over the quartz casing 126 with the washer 145 abutting the bottom of the securing collar's externally threaded wall 150. As can be seen in FIG. 13, which is a top view of the UV light assembly 66, the securing collar 140 includes a plurality of vents 168 that provide access for air, e.g., oxygen, to flow into the quartz casing 126, the importance of which is discussed below.

Each UV light assembly 66 can be attached to a UV light securing assembly 68 and inserted into a respective UV light mount 92 and secured thereto through threaded engagement of the externally threaded wall 150 of the securing collar 140 with an internally threaded wall 170 of the respective UV light mount 92 (see FIGS. 9 and 10). When the UV light assembly 66 and the UV light securing assembly 68 is fully engaged with the UV light mount 92, the UV lamp 132 and quartz casing 126 are positioned within the lower housing 12. Additionally, the first O-ring 146 and second O-ring 148 are compressed between an inwardly extending circumferential shoulder 172 of the UV light mount 92 and the bottom of the externally threaded wall 150 of the securing collar 140, and also compressed between an interior wall of the UV light mount 92 and the quartz casing 126, thus creating a fluid tight seal so that fluid flowing through the lower housing 12 does not escape into the upper housing 14. Additionally, when the UV light assembly 66 is fully inserted into the lower housing 12, each quartz casing 126 is positioned between, and secured by, a set of positioning tabs 112 located on the bottom plate 60. Once each UV light assembly 66 is installed, a respective siphon tube 70 is connected to a portion of the siphoning pipe 134 that extends from the end cap 142.

The UV lamps 132 are preferably low-pressure, amalgam ultraviolet lamps that generate two different wavelengths, e.g., about 254 nanometers (254 nm) and about 185 nanometers (185 nm) of UVC light. The UVC light emitted in the 254 nm range can effectively destroy the nucleic acids in microorganisms, which disrupts their DNA and removes their reproductive capabilities, eliminating the formation of subsequent generations, and eventually killing them. Accordingly, the 254 nm wavelength UV light disinfects and sanitizes the water. Additionally, as discussed above, the sleeve 58 is made of a reflective material, e.g., stainless steel, so that the generated UV light reflects off of the sleeve 58 to increase the exposure of the water to the 254 nm wavelength UV light. Additionally, the sleeve 58 reduces UV exposure of the lower housing 12 itself, which may be constructed of a clear UV-resistant plastic polymer that can be damaged over time due to excessive UV exposure. Thus, the sleeve 58 prolongs the life of the lower housing 12, as well as any other components constructed from the plastic polymer. The UVC light emitted in the 185 nm range is utilized for ozone generation. Particularly, the UVC light emitted in the 185 nm range converts oxygen to ozone through corona discharge and the passing of air containing oxygen over the UV lamps 132. Therefore, the oxygen contained within the air between the quartz casing 126 and the UV lamp 132 is converted into ozone by the 185 nm wavelength UV light emitted by the UV lamp 132. As the ozone is generated, it is contained by the quartz casing 126 and drops to the bottom of the lower end 128 of the quartz casing 126 because the generated ozone has a greater density than air. The generated ozone is removed from the quartz casing 126 and introduced into the fluid stream through a tubing system in which the siphoning pipes 134 are connected to the siphon tubes 70 that, in turn, are connected to the siphon tube manifold 108 which, in turn, is connected with the venturi tube 50, which is finally connected with the venturi 52 located on the inlet pipe 32. When water flows through the inlet pipe 32 and into the lower housing 12 a pressure differential is created in the venturi 52 causing a suction effect to occur in the venturi tube 50 connected with the venturi 52. This suction effect causes the siphoning pipes 134 to draw ozone from the bottoms of the quartz casings 126, through the siphoning pipes 134, the siphoning tubes 70, the siphon tube manifold 108, the venturi tube 50, and the venturi 52, whereupon the ozone is introduced/injected into the water flowing through the inlet pipe 32. As the ozone is removed, air is drawn into the quartz casing 126 through the plurality of vents 168 that are provided in the securing collar 140, which are open to atmosphere. Accordingly, the oxygen supply is constantly being replenished as ozone is generated. The ozone that is introduced into the water acts to oxidize, and thus destroy, organic matter, further sterilizing the water. It is noted that the UV lamps 132 need not emit wavelengths in both the 254 nanometer range and the 185 nanometer range, and that the UV lamps 132 could emit a single wavelength of light, if desired.

Turning now to the flow of fluid through the sterilization system 10, fluid generally flows into the sterilization system 10 at the inlet port 24 and exits the sterilization system 10 at one of the first and second outlet ports 26, 28. The fluid flowing through the sterilization system 10 generally flows in a serpentine pattern due to the orientation of the flow regions, which will now be discussed in greater detail. Particularly, fluid is provided to the system 10 by the inlet pipe 32 and generally flows through the system 10 as follows: from the inlet flow region 114, to the pre-sterilization region 116, to the sterilization region 118, to the post-sterilization region 120, and finally to one of the first and second outlet flow regions 122, 124 where the water is circulated to the pool or spa by the outlet pipe 34. The inlet pipe 32 is in fluidic communication with the pool or spa, such that the water flowing through the inlet pipe 32 is pool/spa water that is recirculated to the pool/spa after sterilization by the outlet pipe 34.

Fluid is first introduced to the system 10 at the inlet pipe 32 where it flows across the inlet flow region 114 and the venturi 52. As the fluid flows across the venturi 52, a pressure differential is created in the venturi 52 and ozone is suctioned therethrough, as discussed above, and introduced into the flow. As the liquid flows from the inlet flow region 114 to the pre-sterilization region 116, the fluid flows towards the perforated lower annular portion 76 of the sleeve 58. The fluid then flows across the perforated lower portion 76 of the sleeve 58 and into the sterilization region 118 within the sleeve 58. The UV light assemblies 66 are positioned within the sterilization region 118, such that they sterilize fluid flowing through the sterilization region 118. Accordingly, the fluid flows through the sterilization region 118, and across the UV light assemblies 66, and toward the perforated upper annular portion 78. The fluid is sterilized by the UV light assemblies 66 while it is in the sterilization region 118, as well as by the ozone introduced by the venturi 52 in the inlet flow region 114. The fluid then flows across the perforated upper portion 78 and into the post-sterilization region 120. From there, the fluid flows into one of the first and second outlet flow regions 122, 124, exits through one of the first and second outlet ports 26, 28, and is returned to the pool/spa through the outlet pipe 34.

The fluid flowing into the system 10 and toward the perforated lower portion 76 is generally very turbulent prior to flowing across the perforated lower portion 76 and into the sterilization region 118. However, the perforated lower portion 76 is specifically designed to create a more uniform flow within the sterilization region 118, reduce air pockets, normalize the residence time of the fluid molecules, normalize the velocity of the fluid, and increase uniformity of treatment. Without the perforated lower portion 76, the fluid flowing through the system 10 would be very turbulent and generally random, meaning that some of the fluid molecules may flow through the entire system very quickly, e.g., have a low residence time, while other fluid molecules may take a very long time to flow through the system, e.g., have a high residence time. In this situation, there would be a discrepancy between treatment and sterilization of the fluid molecules that form the flowing fluid, with some of the fluid molecules not having a sufficient “residence” time to be fully sterilized.

As described above, with the sleeve 58 installed in the lower housing 12, water is forced into a more controlled flow pattern where it cannot flow directly from the inlet to the outlet, but instead must flow in a serpentine pattern. Essentially, the water flows through the system 10 in a controlled plug flow pattern that enhances the effectiveness of the sterilization system 10. Additionally, the sleeve 58 reduces air buildup and/or entrapment of air in the top of the lower housing 12, especially at lower flow rates. This occurs because the sleeve 58 creates a “stovepipe” effect where the flow is forced over the top of the sleeve 58, e.g., through the perforated upper annular portion 78, which evacuates air from the top portion of the central cavity 82. Additionally, the perforated lower portion 76 and the perforated upper portion 78 lower the pressure across the system 10, and can result in greater open flow area that reduces the head loss through the system 10. Further, the sleeve 58 can be sized so that the annular regions between the sleeve 58 and the inside wall of the lower housing 12, e.g., the pre-sterilization region 116 and the post-sterilization region 120, are sized with an open area equal to or greater than the port area of the pipes 32, 34 connected to the sterilization system 10, resulting in reduced head loss through the sterilization system 10.

Further, the perforations included in the sleeve 58 act as a baffle with the effect of causing large bubbles of air or gas, e.g., ozone, to break apart, resulting in smaller bubble sizes, which in turn can result in a greater mass transfer through the unit thus enhancing the sterilization performance of the system 10. Additionally, utilizing a cylindrical sleeve, e.g., sleeve 58, as a baffle provides greater surface area to generate a baffle effect than traditional baffles, which are generally flat, perforated plates. The traditional flat, perforated plate baffles are limited in surface area to less than the cross-sectional area of an associated pipe or vessel, while the cylindrical sleeve 58 is capable of having an increased surface area for generating a baffle effect.

The perforations included in the perforated upper and lower annular portions 76, 78 can be any size and/or shape, and can also be patterned to shape the flow into, across, and out of the sleeve 58, as well as direct flow to different parts of the vessel to enhance treatment of the water. For example, a mixture of small and large perforations can be included, with the small perforations being on a portion of the perforated upper and lower annular portions 76, 78 adjacent the inlet flow region 114 and one of the outlet flow regions 122, 124 and the large perforations being on an opposite side of the small perforations. Such a configuration could allow more equal distribution of flow and more normalized fluid velocities through the sterilization region 118. In another example, varying patters of perforations around the perforated upper and lower annular portions 76, 78 could be utilized to direct flow to desired sections of the sterilization region 118 and to optimize head loss characteristics within the lower housing 12. The perforations included in the upper and lower annular portions 76, 78 could be patterned to allow light to escape the sleeve 58 in a desired pattern or orientation, such that a company logo or other indicia can be displayed when the sterilization system 10 is operating in order to achieve a desired aesthetic or marketing goal.

Additionally, the sleeve 58, and more specifically the perforated upper and lower annular portions 76, 78 thereof, can be utilized to strain fluid entering the sterilization region 118 to prevent ingress of debris into the sterilization region 118, which could damage the UV light assemblies 66, and particularly the quartz casing 126. Further, the sleeve 58 and the perforated upper and lower annular portions 76, 78 thereof can be used to strain fluid leaving the sterilization region 118 to prevent the egress of debris from the treatment chamber in the event that the quartz casings 126, or other component of the UV light assemblies 66, are damaged, e.g., fractured.

The sleeve 58 also significantly reduces, or eliminates, direct impingement of incoming fluid on the quartz casings 126, reducing the likelihood of fracturing the quartz casings 126 due to the force of flow through the system 10, e.g., at startup. The sleeve 58 additionally reduces vibration of the quartz casings 126 during operation since the perforated upper and lower annular portions 76, 78 thereof redirects flow around the sleeve 58, thus reducing the turbulence of flow and forces that would otherwise act directly on, and result in extreme vibration of, the quartz casings 126.

Furthermore, the O-ring assembly 62, and the fluid-tight seal created thereby, ensures that there are no stagnant areas in the lower housing 12 during operation, thereby eliminating the possibility of waterborne buildup of bacteria, etc., in the areas within the vessel that are not exposed to UV light. In shut-off conditions, all fluid that was retained in the sterilization region 118 and the post-sterilization region 120 has been treated, while all fluid in the pre-sterilization region 116 will be automatically forced through the sterilization region 118 once the system 10 is restarted, ensuring that no untreated water leaves the system 10.

The present disclosure provides for additional modularity in implementation, whereby a user can mix lamps of different intensities and/or wavelengths within the same unit. For example, in a three lamp system, such as the one illustrated in connection with FIGS. 1-10, a user may desire to have one UV lamp at a first intensity and the other two UV lamps at a higher or lower intensity so that different treatment zones could be created within the system. Additionally and/or alternatively, a user may desire to have one UV lamp generating only 185 nm wavelength UV light for the production of ozone, while the other two UV lamps generate 254 nm wavelength UV light for the purpose of direct treatment of the fluid. The modularity of the lamps can be combined with the perforation design discussed above to further create various treatment zones as well as optimize performance. For example, in areas of the system where fluid velocities are higher, a higher intensity lamp could be positioned to normalize the dosage of UV light with areas of lower fluid velocities, which could have lower intensity UV lamps installed therein. This modularity allows for a user to achieve different results based on a desired application.

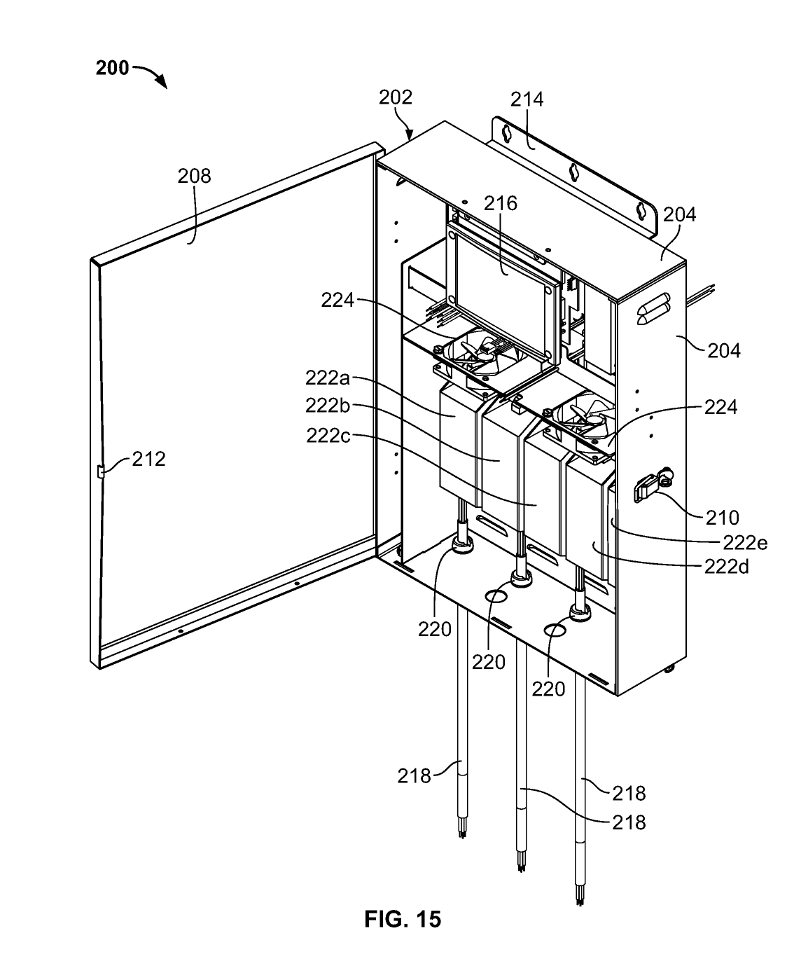

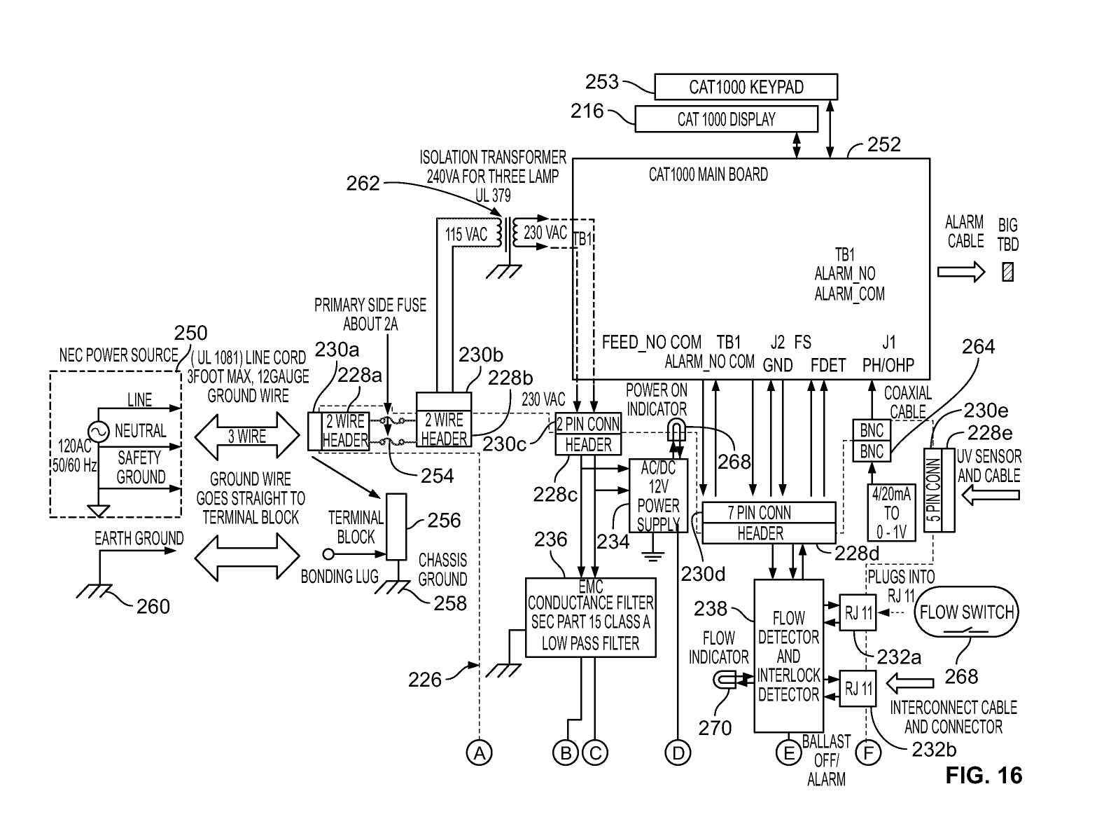

FIGS. 14 and 15 show the control panel 200 of the present disclosure. The control panel 200 includes a housing 202 having a body 204, a front cover 206, and a cover panel 208 pivotably mounted to the body 204. The housing 204 includes a latch 210 that is configured to engage a hook 212 on the cover panel 208 such that the latch 210 can be secured with the hook 212 so that the cover panel 208 is secured across the front cover 206. The housing 204 further includes a mounting bracket 214 that assists with mounting the control panel 200 to a wall. The control panel 200 further includes a display 216 and a plurality of cables 218 that extend from the control panel 200 to the sterilization system 10 to provide power and control of the UV light assemblies 66. The cables 218 can access the sterilization system 10 through the plurality of inlets 56. Additionally, the cables 218 can each include a plug (not shown) that can mate with the end cap 142. As shown in FIG. 15, which is a perspective view of the control panel 200 with the front cover 206 removed, the body 204 includes a plurality of grommets 220 through which the control cables 218 extend. The control cables 218 are each operatively connected with a plurality of ballasts 222a-222e housed by the housing 202. The housing additionally includes a plurality of fans 224 for cooling the ballasts 222a-222e. The ballasts 222a-222e start and regulate electrical current supplied to the UV lamps 132.

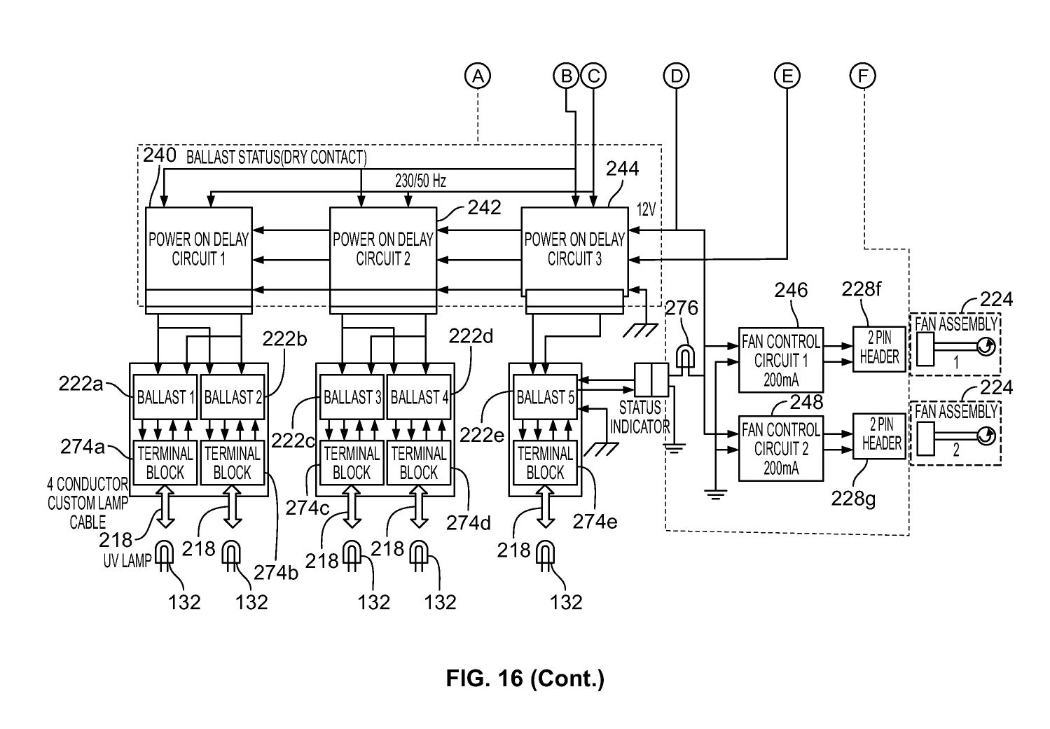

FIG. 16 is a schematic diagram of a controller 226 included in the control panel 200 of FIG. 14. The controller 226 includes a plurality of headers 228a, 228b, 228c, 228d, 228e, 228f, 228g a plurality of connectors 230a, 230b, 230c, 230d, 230e and a plurality of inputs 232a, 232b. The controller 226 can further include an AC/DC 12 volt power supply 234, an EMC conductance filter 236, a flow detector and interlock detector 238, a first power-on delay circuit 240, a second power-on delay circuit 242, a third power-on delay circuit 244, a first fan control circuit 246, and a second fan control circuit 248. The controller 226 can be connected with a power source 250 and a main control board 252. The power source 250 can be connected to the first connector 228a and header 230a, which in turn is in electrical communication with the second header 228b and connector 230b with an intermediate fuse 254 therebetween. The first header 228a and connector 230a can be connected with a terminal block 256 for grounding with a chassis ground 258 and an earth ground 260. The second connector 230b can be connected with an isolation transformer 262 that is connected with the main control board 252. The isolation transformer 262 receives 115V AC power from the second header 228b and connector 230b and transforms it to 230V AC power.

The main control board 252 is connected with the display 216 and can be connected with a keypad 253. The main control board 252 is connected with the controller 226 at the third connector 230c, the fourth connector 230d, and also with a BNC connector 264 of the controller 226. The BNC connector 264 is connected with a converter 266. The main control board 252 provides the controller 226 with power through the third header 228c and third connector 230c, and provides commands through the fourth header 228d and fourth connector 230d. The main control board 252 also receives data from the controller 226 through the fourth header 228d and fourth connector 230d. The third header 228c is connected with the AC/DC 12V power supply 234 and the EMC conductance filter 236. The AC/DC 12V power supply 234 is connected with a power on indicator 268 and provides power to the first, second, and third power on delay circuits 240, 242, 244 and the first and second fan control circuits 246, 248. The first and second fan control circuits 246, 248 are connected to and control the fans 224. The fourth header 228d is connected with the flow detector and interlock detector 238, and connects the flow detector and interlock detector 238 with the main control board 252, such that the main control board 252 can provide instructions and data to the flow detector and interlock detector 238 and can receive data from the flow detector and interlock detector 238. The flow detector and interlock detector 238 can be connected with the first and second inputs 232a, 232b, which can be respectively connected with a flow switch 268 and the sensor 72. The flow detector and interlock detector 238 is also in communication with the first, second, and third power delay circuits 240, 242, 244 and provides instructions for the ballasts 222a-222e to be turned off when the detector 238 determines that the sterilization system 10 has been opened or there is no flow through the sterilization system 10. The flow detector and interlock detector 238 can also include a flow detector light 270 that is illuminated when a flow is detected through the sterilization system 10.

FIGS. 15 and 16 illustrate five ballasts 222a-222e, demonstrating that the controller 226 can be used with a sterilization system having up to five UV lamps 132. However, the controller 226 can be used with a sterilization system having less than five UV lights, e.g., the sterilization system 10 of FIGS. 1-13 that has three UV lamps 132. Alternatively, the controller 226 can be provided with more than five ballasts so that the sterilization system 10 can have more than five UV lights. Accordingly, the number of ballasts and UV lights described herein is for illustrative purposes only, and the present disclosure should not be limited to these numbers. Each of the power-on delay circuits 240, 242, 244 can be connected with one or two ballasts 222a-222e (FIG. 16 shows the first and second power on delay circuits 240, 242 connected with two ballasts 222a-222d each, and the third power on delay circuit 244 connected with a single ballast 222e). The power on delay circuits 240, 242, 244 delay (stagger) the start times of the ballasts 222a-222e so that an overload does not occur. Each of the ballasts 222a-222e is connected to a terminal block 274a-274e that is connected with a UV lamp 132 by a control cable 218, which places the ballast 222a-222e in electrical communication with a respective UV lamp 132. The ballasts 222a-222e and the first and second fan control circuits 246, 248 can be in communication with a status indicator 276 that illuminates when the ballasts 222a-222e and the fan control circuits 246, 258 are operational.

Having thus described the invention in detail, it is to be understood that the foregoing description is not intended to limit the spirit or scope thereof. It will be understood that the embodiments of the present invention described herein are merely exemplary and that a person skilled in the art may make many variations and modification without departing from the spirit and scope of the invention. All such variations and modifications, including those discussed above, are intended to be included within the scope of the invention.

What is claimed is:

1. A fluid sterilization system, comprising:
a housing having a body, a fluid inlet, and a fluid outlet, wherein fluid to be sterilized flows into the fluid inlet and into the body, and sterilized fluid flows out of the fluid outlet;
a sleeve positioned within the central cavity, the sleeve including a first plurality of openings disposed radially about a first end of the sleeve and a second plurality of openings disposed radially about a second end of the sleeve, wherein the fluid to be sterilized flows through the first plurality of openings and into the sleeve, and sterilized fluid flows out of the second plurality of openings, and wherein the sleeve creating uniform fluid flow through the sleeve and between the first plurality of openings and the second plurality of openings;
at least one ultraviolet light assembly positioned within the sleeve and generating ultraviolet light for sterilizing fluid within the sleeve; and
means for injecting ozone into the fluid to be sterilized proximal to the fluid inlet.

2. The fluid sterilization system of claim 1, further comprising an O-ring assembly positioned about an outer surface of the sleeve and dividing a space between the sleeve and the body of the housing into an untreated fluid region and a treated fluid region, the O-ring assembly creating a seal between the outer surface of the sleeve and an inner surface of the body.

3. The fluid sterilization system of claim 1, wherein the first plurality of openings comprises a first plurality of cutouts formed in the sleeve and the second plurality of openings comprises a second plurality of cutouts formed in the sleeve.

4. The fluid sterilization system of claim 1, wherein the housing comprises a lower housing portion and a base portion attached to the lower housing portion.

5. The fluid sterilization system of claim 4, further comprising an upper housing portion attached to an upper end of the lower housing portion.

6. The fluid sterilization system of claim 5, further comprising a cap attached to the upper housing portion and a nut for coupling the upper housing portion to the lower housing portion.

7. The fluid sterilization system of claim 5, further comprising a manifold attached to the upper housing portion, the at least one ultraviolet light assembly coupled to and supported by the manifold.

8. The fluid sterilization system of claim 7, further comprising a securing assembly for securing the at least one ultraviolet light assembly to the manifold.

9. The fluid sterilization system of claim 7, wherein the at least one ultraviolet lamp assembly is removable from the manifold and the sterilization system.

10. The fluid sterilization system of claim 1, wherein the means for injecting ozone comprises a venturi assembly for injecting ozone into the fluid to be sterilized.

11. The fluid sterilization system of claim 10, wherein the at least one ultraviolet light assembly comprises a quartz tube, an ultraviolet lamp positioned within the quartz tube, and a siphon tube positioned within the quartz tube.

12. The fluid sterilization system of claim 11, wherein the ultraviolet lamp generates ozone within the quartz tube, and the siphon tube suctions the ozone out of the quartz tube.

13. The fluid sterilization system of claim 12, further comprising a venturi tube interconnecting the siphon tube to the venturi assembly, the venturi tube transferring ozone from the siphon tube to the venturi assembly.

14. The fluid sterilization system of claim 1, further comprising a sensor for sensing output of the at least one ultraviolet light assembly.

15. The fluid sterilization system of claim 1, further comprising a controller in electrical communication with the at least one ultraviolet light assembly, the controller controlling operation of the at least one ultraviolet light assembly.

16. The fluid sterilization system of claim 15, wherein the controller activates an alarm if the housing of the fluid sterilization system is not closed prior to operation.

17. The fluid sterilization system of claim 1, wherein the sleeve is reflective.

18. The fluid sterilization system of claim 1, wherein the sleeve is formed from stainless steel, a composite material, a thermoplastic material, polytetrafluoroethylene, or perfluoroalkoxy.

19. The fluid sterilization system of claim 1, wherein the sleeve is removable from the housing.

20. The fluid sterilization system of claim 19, wherein the sleeve is replaceable.

21. The fluid sterilization system of claim 1, wherein the first and second plurality of openings comprises first and second perforations formed in the sleeve.

22. The fluid sterilization system of claim 21, wherein the first and second perforations allow fluid to pass therethrough and retain a high percentage of reflective surface.

23. The fluid sterilization system of claim 1, wherein the first plurality of openings form a first cylindrical baffle that has an open area equal to or greater than an open area of the fluid inlet, and the second plurality of openings form a second cylindrical baffle that has an open area equal to or greater than an open area of the fluid outlet.

24. The fluid sterilization system of claim 23, wherein the first and second cylindrical baffles diffuse the fluid flowing through the housing to regulate bubble size and increase mass transfer of the fluid sterilization system.

25. The fluid sterilization system of claim 1, wherein the first and second plurality of openings are patterned to shape or direct the flow through the sleeve to enhance treatment of the fluid.

26. The fluid sterilization system of claim 1, wherein the sleeve is perforated to form indicia on the sleeve, through which light from the at least one ultraviolet light assembly shines when the sterilization system is in operation.

27. The fluid sterilization system of claim 1, wherein the at least one ultraviolet lamp assembly is modular, removable, and replaceable.

28. The fluid sterilization system of claim 27, wherein the at least one ultraviolet lamp assembly is replaceable by a second at least one ultraviolet lamp assembly having a different lamp wattage or wavelength.

29. The fluid sterilization system of claim 1, further comprising a first number of ultraviolet lamp assemblies, the first number of ultraviolet lamp assemblies being replaceable by a second number of ultraviolet lamp assemblies, the second number being different than the first number.

30. A method of sterilizing fluid, comprising:
providing a fluid sterilization system having a housing with an inlet port and an outlet port, a sleeve positioned within the housing, at least one ultraviolet lamp assembly positioned within the sleeve, and means for generating ozone;
allowing fluid to be sterilized to flow into the inlet port;
introducing ozone generated by the means for generating ozone into the fluid proximal the inlet port, the ozone sterilizing the fluid;
directing the fluid through a first plurality of openings formed in the sleeve proximal to a first end of the sleeve, the sleeve creating uniform fluid flow within the sleeve;
exposing the fluid to ultraviolet light generated by the at least one ultraviolet lamp assembly, the ultraviolet light sterilizing the fluid; and
directing the fluid through a second plurality of openings formed in the sleeve proximal to a second end of the sleeve, and out the outlet port of the fluid sterilization system.

31. The method of claim 30, wherein the step of introducing the ozone into the fluid comprises introducing the ozone into the fluid using a venturi assembly mounted proximal to the inlet port.

32. The method of claim 31, further comprising straightening flow of the fluid past the at least one ultraviolet lamp assembly using the sleeve.

33. A fluid sterilization system, comprising:
a housing having a body, a fluid inlet, and a fluid outlet, wherein fluid to be sterilized flows into the fluid inlet and into the body, and sterilized fluid flows out of the fluid outlet;
a sleeve positioned within the central cavity, the sleeve including a first plurality of openings disposed radially about a first end of the sleeve and a second plurality of openings disposed radially about a second end of the sleeve, wherein the fluid to be sterilized flows through the first plurality of openings and into the sleeve, and sterilized fluid flows out of the second plurality of openings; and
at least one ultraviolet light assembly positioned within the sleeve and generating ultraviolet light for sterilizing fluid within the sleeve.

34. The fluid sterilization system of claim 33, further comprising an O-ring assembly positioned about an outer surface of the sleeve and dividing a space between the sleeve and the body of the housing into an untreated fluid region and a treated fluid region, the O-ring assembly creating a seal between the outer surface of the sleeve and an inner surface of the body.

35. The fluid sterilization system of claim 33, wherein the first plurality of openings comprises a first plurality of cutouts formed in the sleeve and the second plurality of openings comprises a second plurality of cutouts formed in the sleeve.

36. The fluid sterilization system of claim 33, wherein the housing comprises a lower housing portion and a base portion attached to the lower housing portion.

37. The fluid sterilization system of claim 36, further comprising an upper housing portion attached to an upper end of the lower housing portion.

38. The fluid sterilization system of claim 37, further comprising a cap attached to the upper housing portion and a nut for coupling the upper housing portion to the lower housing portion.

39. The fluid sterilization system of claim 37, further comprising a manifold attached to the upper housing portion, the at least one ultraviolet light assembly coupled to and supported by the manifold.

40. The fluid sterilization system of claim 39, further comprising a securing assembly for securing the at least one ultraviolet light assembly to the manifold.

41. The fluid sterilization system of claim 39, wherein the at least one ultraviolet lamp assembly is removable from the manifold and the sterilization system.

42. The fluid sterilization system of claim 33, further comprising a venturi assembly for injecting ozone into the fluid to be sterilized.

43. The fluid sterilization system of claim 42, wherein the at least one ultraviolet light assembly comprises a quartz tube, an ultraviolet lamp positioned within the quartz tube, and a siphon tube positioned within the quartz tube.

44. The fluid sterilization system of claim 43, wherein the ultraviolet lamp generates ozone within the quartz tube, and the siphon tube suctions the ozone out of the quartz tube.

45. The fluid sterilization system of claim 44, further comprising a venturi tube interconnecting the siphon tube to the venturi assembly, the venturi tube transferring ozone from the siphon tube to the venturi assembly.

46. The fluid sterilization system of claim 33, further comprising a sensor for sensing output of the at least one ultraviolet light assembly.

47. The fluid sterilization system of claim 33, further comprising a controller in electrical communication with the at least one ultraviolet light assembly, the controller controlling operation of the at least one ultraviolet light assembly.

48. The fluid sterilization system of claim 47, wherein the controller activates an alarm if the housing of the fluid sterilization system is not closed prior to operation.

49. The fluid sterilization system of claim 33, wherein the sleeve is reflective.

50. The fluid sterilization system of claim 33, wherein the sleeve is formed from stainless steel, a composite material, a thermoplastic material, polytetrafluoroethylene, or perfluoroalkoxy.

51. The fluid sterilization system of claim 33, wherein the sleeve is removable from the housing.

52. The fluid sterilization system of claim 51, wherein the sleeve is replaceable.

53. The fluid sterilization system of claim 33, wherein the first and second plurality of openings comprises first and second perforations formed in the sleeve.

54. The fluid sterilization system of claim 53, wherein the first and second perforations allow fluid to pass therethrough and retain a high percentage of reflective surface.

55. The fluid sterilization system of claim 33, wherein the first plurality of openings form a first cylindrical baffle that has an open area equal to or greater than an open area of the fluid inlet, and the second plurality of openings form a second cylindrical baffle that has an open area equal to or greater than an open area of the fluid outlet.

56. The fluid sterilization system of claim 55, wherein the first and second cylindrical baffles diffuse the fluid flowing through the housing to regulate bubble size and increase mass transfer of the fluid sterilization system.

57. The fluid sterilization system of claim 33, wherein the first and second plurality of openings are patterned to shape or direct the flow through the sleeve to enhance treatment of the fluid.

58. The fluid sterilization system of claim 33, wherein the sleeve is perforated to form indicia on the sleeve, through which light from the at least one ultraviolet light assembly shines when the sterilization system is in operation.

59. The fluid sterilization system of claim 33, wherein the at least one ultraviolet lamp assembly is modular, removable, and replaceable.

60. The fluid sterilization system of claim 59, wherein the at least one ultraviolet lamp assembly is replaceable by a second at least one ultraviolet lamp assembly having a different lamp wattage or wavelength.

61. The fluid sterilization system of claim 33, further comprising a first number of ultraviolet lamp assemblies, the first number of ultraviolet lamp assemblies being replaceable by a second number of ultraviolet lamp assemblies, the second number being different than the first number.
